(19) United States
(12) Patent Application Publication
(10) Pub. No.: US 2013/0133501 A1
(43) Pub. Date: May 30, 2013

(54) CUTTING ELEMENT FOR OSCILLATING POWER TOOL

(71) Applicant: Xiaofeng Zhang, Nanjing (CN)

(72) Inventor: Xiaofeng Zhang, Nanjing (CN)

(73) Assignee: CHERVON (HK) LIMITED, Wanchai (HK)

(21) Appl. No.: 13/590,457

(22) Filed: Aug. 21, 2012

(30) Foreign Application Priority Data
Nov. 24, 2011 (CN) 201110378781.4

(51) Int. Cl. B26D 1/30

(52) U.S. Cl. 83/697

(57) ABSTRACT

A cutting element includes a main body extending in a longitudinal direction, a mounting hole and a cutting portion for acting on a piece to be processed. The main body defines an axis extending in the longitudinal direction, the mounting hole is arranged at a first end of the main body for connection to the output shaft of an oscillating power tool and the cutting portion is arranged at a second end of the main body and has a first cutting portion and a second cutting portion. The second cutting portion protrudes from the first cutting portion laterally. The first cutting portion is adapted to cut the piece in a feeding direction and the second cutting portion is adapted to cut the piece in a direction perpendicular to the feeding direction.

### RELATED APPLICATION INFORMATION

This application claims the benefit of CN 201110378781.4, filed on Nov., 24, 2011, the disclosure of which is incorporated herein by reference in its entirety.

### BACKGROUND

The following generally relates to cutting elements and, more particularly, to a cutting element used on a portable oscillating power tool. A commonly used portable oscillating power tool generally includes an output shaft performing an oscillating motion about its axis. For example, U.S. Pat. No. RE 36,909 discloses an oscillating power tool with a driving device, which includes a housing, a motor arranged within the housing, and a main shaft driven by the motor. The main shaft has a rotation axis and an eccentric portion which deviates from the rotation axis. A shifting fork is driven by the main shaft and operatively connected to a working unit. One end of the shifting fork is pivotally connected to the output shaft, and the other end is formed with a pair of branch forks and locked to the eccentric portion of the main shaft. The output shaft is substantially perpendicular to the rotation axis of the main shaft. The rotation motion of the main shaft around the rotation axis is converted into the pivoting motion of the shifting fork along the output shaft so as to force the output shaft to move and to drive a working head to operate. Moreover, when the output shaft is installed with different working heads by the user, the tool can achieve various operation functions. A commonly used working head may be a straight saw blade, a circular saw blade, a triangle sanding disc, or a scraper, which can achieve a working function such as sawing, cutting, sanding, or scraping.

A user may mount a straight saw blade to the output shaft and operate the tool. FIGS. 17-19 show a typical saw blade 4′, which includes a main body 41′ and a cutting portion 43′ having a plurality of saw teeth. A first end of the main body 41′ defines a mounting hole 42′ for connecting with the output shaft of the oscillating power tool. When the saw blade 4′ is used to cut a work piece to be processed, the saw blade 4′ performs an oscillating motion around the axis of the output shaft with an oscillating frequency in the range from 10,000 to 25,000 times per minute and an oscillating angle is in the range from 0.5° to 7°. However, under the circumstance of high frequency oscillating, when the cutting element performs a cutting in a feeding direction indicated by an arrow D, it is limited by the flank of the work piece, and the friction force created between the saw blade and the work piece becomes larger and larger. When the commonly used saw blade cuts the work piece, a sawing path is substantially ladder-shaped theoretically, but the extent of the left and right oscillating motion of the saw blade is limited gradually, thus the cutting efficiency is gradually decreased and scrap discharge of the saw blade gradually hard to achieve, and finally the saw blade is blocked and can not move forward. Meanwhile, during the cutting process, due to the large oscillation caused by the high frequency oscillating, the user may feel hand numbness, thereby affecting the convenience of the operation.

### SUMMARY

The following describes a cutting element used in an oscillating power tool which can reduce vibration and which effectively enhances the cutting efficiency and discharge of scraps.

More particularly, the cutting element is adapted for use with an oscillating power tool in which an output shaft moves in an oscillating motion about its axis. The oscillating power tool includes a motor and a transmission mechanism for converting a rotation motion of the motor into an oscillating motion of the output shaft about its axis. The cutting element includes a main body extending in the longitudinal direction, a mounting hole and a cutting portion for acting on the work piece to be processed. The main body defines an axis extending in the longitudinal direction, the mounting hole is arranged at a first end of the main body and connected to the output shaft of the oscillating power tool, and the cutting portion is arranged on a second end of the main body and has a first cutting portion and a second cutting portion, wherein the second cutting portion protrudes from the first cutting portion laterally, and the first cutting portion cuts the work piece to be processed in a feeding direction, while the second cutting portion cuts the work piece to be processed in a direction perpendicular to the feeding direction. Preferably, the second cutting portion extends and protrudes directly from an end edge of the first cutting portion.

The main body may include a side surface with the first cutting portion having a first cutting surface and a second cutting surface, and with the second cutting portion having a third cutting surface connected to the first cutting surface or the second cutting surface and a fourth cutting surface connected to the side surface. The side surface may include a first side surface, a second side surface and a third side surface, wherein the first side surface is connected to the first end of the main body, the second side surface is connected to the first side surface and the third side surface, and the third side surface is connected to the fourth cutting surface. The cutting element may have two of the second side surfaces being parallel to each other. The first side surface, the second side surface and the third side surface may form a groove together, which efficiently enhances the effect of scrap discharge.

Further, the material of at least part of the second cutting portion may have the same rigidity as the material of the first cutting portion. Preferably, the material of the first cutting portion and at least part of the second cutting portion is high speed steel. The material of the cutting portion is different from that of the main body. Preferably, the material of the cutting portion has a higher rigidity than the material of the main body. For example, the material of the cutting portion is high carbon steel and the material of the main body is high speed steel, which can efficiently increase the life of the cutting element, in particular the using life of the second cutting portion.

Further, the first cutting portion may be wave-shaped where the third cutting surface of the second cutting portion intersects the first cutting surface or the second cutting surface of the first cutting portion. The third cutting surface and the fourth cutting surface may define an angle α ranging from 30° to 150°. The third cutting surface may have an angle β less than or equal to 90° with respect to the feeding direction. The second cutting portion may define a second length less than 3 mm in a lateral direction. The first cutting portion may have a top end defining a height with respect to a direction opposite to the feeding direction. Within this height, at least one second cutting portion is arranged. Preferably, the height is less than or equal to 10 mm.

Further, the first end of the main body may be parallel to the second end of the main body. The cutting element may be fixed to the output shaft through a fastener. The perpendicular distance between the first end and the second end may be at least equal to the thickness of the fastener between the first end and the second end, so as to facilitate operation of the oscillating power tool in a relative narrow space. The mounting hole of the cutting element may have eight grooves, and each two adjacent grooves may be connected to each other by a side surface of the mounting hole.

In order to achieve the cutting function of the second cutting portion, the cutting element is mounted to the oscillating power tool. When the cutting element is deflected within a certain angle, the second cutting portion protrudes from the first cutting portion laterally. Particularly, when the cutting element deflects to the maximum angle, the second cutting portion still protrudes from the first cutting portion laterally.

### BRIEF DESCRIPTION OF THE DRAWINGS

FIG. 1 is a schematic view showing a first embodiment of a cutting element mounted to an oscillating power tool, the cutting element includes saw teeth;

FIG. 2 is a plan schematic view of the cutting element of FIG. 1;

FIG. 3 is a sectional view along line C-C in FIG. 2;

FIGS. 4 and 5 are respectively a plan view and a perspective view of the portion in circle A in FIG. 2;

FIGS. 6 and 7 are respectively a plan view and a perspective view of a portion of saw teeth of a second embodiment of a cutting element;

FIGS. 8 and 9 are respectively a plan view and a perspective view of a portion of saw teeth of a third embodiment of a cutting element;

FIGS. 10 and 11 are respectively a plan view and a perspective view of the portion in circle B in FIG. 2;

FIGS. 12 and 13 are respectively a plan view and a perspective view of a portion of saw teeth of the third embodiment applied to the portion in circle B;

FIGS. 14 and 15 are respectively a plan view and a perspective view of a part of saw teeth of a fourth embodiment of a cutting element;

FIG. 16 is a schematic view showing the first embodiment of saw blade performing a cutting operation;

FIGS. 17 and 18 are schematic views of a typical cutting element;

FIG. 19 is a schematic view showing that the typical saw blade performing a cutting operation.

### DETAILED DESCRIPTION

A first embodiment of a cutting element for a power tool, in particular a cutting element for an oscillating power tool, is shown in FIG. 1. The oscillating power tool includes a housing 1 within which a motor and a transmission mechanism (not shown) are accommodated. The transmission mechanism includes a main shaft driven by the motor. The main shaft has a rotation axis and an eccentric portion which deviates from the rotation axis. A shifting fork is driven by the main shaft and operatively connected to a working unit. One end of the shifting fork is pivotally connected to an output shaft, and the other end is formed with a pair of branch fork which is locked on the eccentric portion of the main shaft. The output shaft is substantially perpendicular to the rotation axis of the main shaft. The rotation motion of the main shaft about its rotation axis is converted into the pivoting motion of the shifting fork along the output shaft so as to enable the output shaft to move and to drive a working head to operate. The rotation motion of the motor is converted via the transmission mechanism into the oscillating motion of the output shaft 2 about its axis 3. A cutting element 4 is mounted to the output shaft 2 by a fastener 5 so that the cutting element 4 performs an oscillating motion with the output shaft 2. The oscillating frequency of the cutting element 4 and the output shaft 2 is in a range of about 10,000 and 25,000 times per minute and the oscillating angle thereof is between about 0.5° and 7°. With the oscillating motion of high frequency, the cutting element 4 cuts into the work piece gradually. It should be noted that the cutting element may be applied to other oscillating power tools, and not limited to such a transmission mechanism.

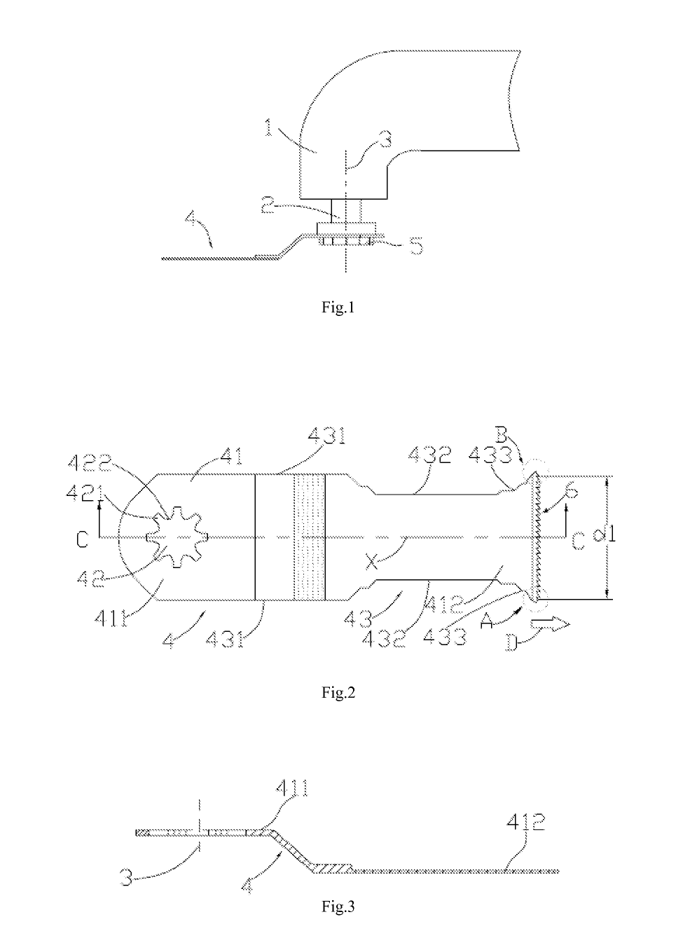

Referring to FIGS. 2-5 and FIGS. 10-11, the cutting element 4 includes a main body 41 extending in the longitudinal direction substantially perpendicular to the axis of the output shaft, a mounting hole 42, and a cutting portion 6 for acting on the work piece to be processed. The main body 41 defines an axis X extending in the longitudinal direction. The mounting hole 42 is defined at a first end 411 and engaged with the output shaft of the oscillating power tool. An inner side wall of the mounting hole 42 defines plurality of grooves 421, and each two adjacent grooves 421 are connected by a side surface 422 of the mounting hole 42. The cutting portion 6 is formed on a second end 412 of the main body 41 opposite to the first end 411. The main body 41 also has a side surface 43. The cutting portion 6 has a first cutting portion 61 and a second cutting portion 62. The first cutting portion 61 has a plurality of sawteeth, and each sawtooth has a first cutting surface 611 and a second cutting surface 612. The second cutting portion 62 includes two cutting edges respectively positioned on the two sides of the axis X which is defined by the main body. The first cutting surfaces 611 are parallel to each other, and the second cutting surfaces 612 are parallel to each other, too. Each cutting edge has a third cutting surface 621 and a fourth cutting surface 622. The first cutting surface 611 shown in FIGS. 4 and 5 is connected with the third cutting surface 621, and the fourth cutting surface 622 is connected with the side surface 43 of the main body. The so-called connection is not limited to a direct connection between the two surfaces shown in FIGS. 4 and 5, and it also means an indirect connection between the two surfaces. For example, the two surfaces may be connected by a planar surface, a curved surface or several planar surfaces, several curved surfaces or the combination of planar surface and curved surface. The first cutting portion 61 laterally defines a first length d1 from one side edge to the other side edge of the first cutting portion. The second cutting portion 62 extends from an end edge of the first cutting portion 61 directly and protrudes from the end edge of the first cutting portion. As shown in FIG. 2, the first length d1 is the distance from the extreme edge of the second cutting surface 612 on the upper end of the first cutting portion to the extreme edge of the first cutting surface 611 on the lower end of the first cutting portion. The second cutting portion 62 laterally defines a second length d2 that is the lateral distance from the edge of one side of the first cutting portion to the intersection line of the third cutting surface and the fourth cutting surface of the second cutting portion on this side. As shown in FIGS. 4 and 5, the second length d2 is the lateral distance from the intersection line of the first cutting surface and the third cutting surface to the intersection line of the third cutting surface 621 and the fourth cutting surface 622. As shown in FIGS. 10 and 11, the second length d2 is the lateral distance from the intersection line of the second cutting surface 622 and the third cutting surface 621 to the intersection line of the third cutting surface 621 and the fourth cutting surface 622. Preferably, the second length d2 is less than 3 mm so that the resistance force for the second cutting portion in the feeding portion can be reduced. If the second length is too long, the cutting element may not perform cutting along the feeding direction normally. The third cutting surface 621 and the fourth surface 622 of the second cutting portion 62 cooperatively define an angle α which ranges from 30° to 150°. For example, the angle α is 85° so that, when the first portion of the cutting element performs a cutting in the feeding direction, the second cutting portion may perform cutting in the direction perpendicular to the feeding direction, thereby forming theoretically a general rectangle sawing path as shown in FIG. 16. Further, the third cutting surface forms an angle β with respect to the feeding direction. Preferably, the angle β is less than or equal to 90°. For example, the angle β is 58° in the illustrated embodiment. In this manner, the third cutting surface may reduce the resistance force for the second cutting portion in the feeding direction.

As shown in FIG. 2, the side surface 43 includes a first side surface 431 connected to the first end 411 of the main body 41, a third side surface 433 connected to the fourth cutting surface, and a second side surface 432 connected to the first side surface 431 and the third side surface 433. The first side surface 431, the second surface 432 and the third surface 433 cooperatively define a groove adjacent to the cutting portion 6, thus facilitating scrap discharge. The cutting element has two second side surfaces 432 parallel to each other. If no groove is defined in the side surface of the cutting element, and during the cutting process, the sawing path is generally ladder-shaped theoretically, thus when the cutting element cuts into the work piece gradually in the feeding direction, the gap between the cutting element and the work piece to be processed becomes smaller gradually, and scrap discharge becomes harder. Therefore, the groove arranged in the cutting element 4 efficiently enhances the effect of scrap discharge.

When the cutting element 4 cuts the work piece to be processed in the feeding direction, the second cutting portion 62 performs cutting in a direction substantially perpendicular to the feeding direction. Furthermore, the oscillation of the machine can be reduced effectively while cutting is performed.

As shown in FIGS. 1-3, the first end 411 and the second end 412 of the main body 41 of the cutting element 4 are arranged parallel to each other. The thickness of the fastener 5 is less than or equal to the vertical distance between the first end 411 and the second end 412. With this arrangement, it is helpful to operate the oscillating power tool in a relatively narrow space.

At least part of the second cutting portion 62 has same material as that of the first cutting portion 61. Preferably, the material of at least part of the second cutting portion 62 has the same rigidity as the material of the first cutting portion 61. For example, the second cutting portion 62 is at least partly made of high speed steel material, and the first cutting portion 61 is also made of high speed steel material. The portion below the intersection line of the third and fourth cutting surface may be formed of high carbon steel. As is known to the person skilled in the art, the rigidity of the high carbon steel is generally lower than that of the high speed steel, so that the second cutting portion of the cutting element 4 is more wearable, thereby achieving a cutting for the work piece to be processed permanently. More conveniently, the main body 41 of the cutting element 4 may be formed of high carbon steel, and the first cutting portion 61 and the second cutting portion 62 of the cutting element 4 are formed of high speed steel, which can efficiently enhance the serve life of the cutting element, in particular the serve life of the second cutting portion.

The saw teeth of the first cutting portion 61 may be wave-shaped, that is, some saw teeth protrude from one end surface of the second end 412, and some saw teeth protrude from the other end surface of the second end 412. This arrangement can enhance the cutting efficiency of the cutting element 4.

The first cutting portion 61 has a top end, namely a plane including the intersection line that is formed by the first cutting surface 611 intersecting the second cutting surface 612 of the first cutting portion 61 and is away from the mounting hole 42. The plane defines a height with respect to the direction opposite to the feeding direction. Within this height, one or more cutting portions may be provided. Preferably, the height is less than or equal to about 10 mm. If a plurality of second cutting portions protruding laterally from the first cutting portion 61 are provided beyond the scope of the height, the resistance force for the cutting element would be increased in the feeding direction, which is harmful to the cutting of the cutting element in the feeding direction. In order to achieve the cutting of the second cutting portion in the direction perpendicular to the feeding direction, when the cutting element 4 is mounted to the oscillating power tool and deflects for a certain angle, the second cutting portion still protrudes from the first cutting portion in the lateral direction. Preferably, as shown in FIG. 16, when the cutting element is swung to the left and right maximum angle, the second cutting portion still protrudes from the first cutting portion in the lateral direction, thereby efficiently enhancing the cutting efficiency of the cutting element.

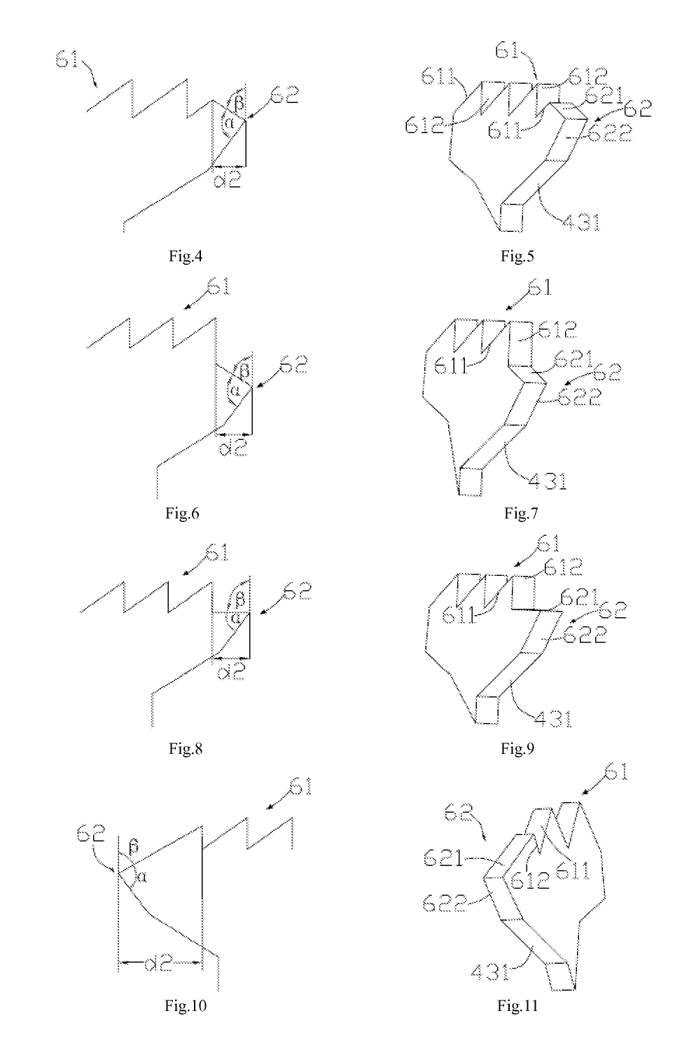

FIGS. 6 and 7 illustrate a portion of the cutting element 4 according to a second embodiment. In this embodiment, and other below, same elements are indicated by the same reference numerals as the first embodiment described above. In the illustrated embodiment, the second cutting surface 612 of the first cutting portion 61 is connected to the third cutting surface 621 of the second cutting portion 62 by a planar surface and the angle α defined between the third cutting surface 621 and the fourth cutting surface 622 is ranged from 30° to 150°. Preferably, in this embodiment, the angle α is 85°. The angle β is defined between the third cutting surface 621 and the feeding direction, which is preferably less than or equal to 90°. For example, in this embodiment, the angle β is 58°.

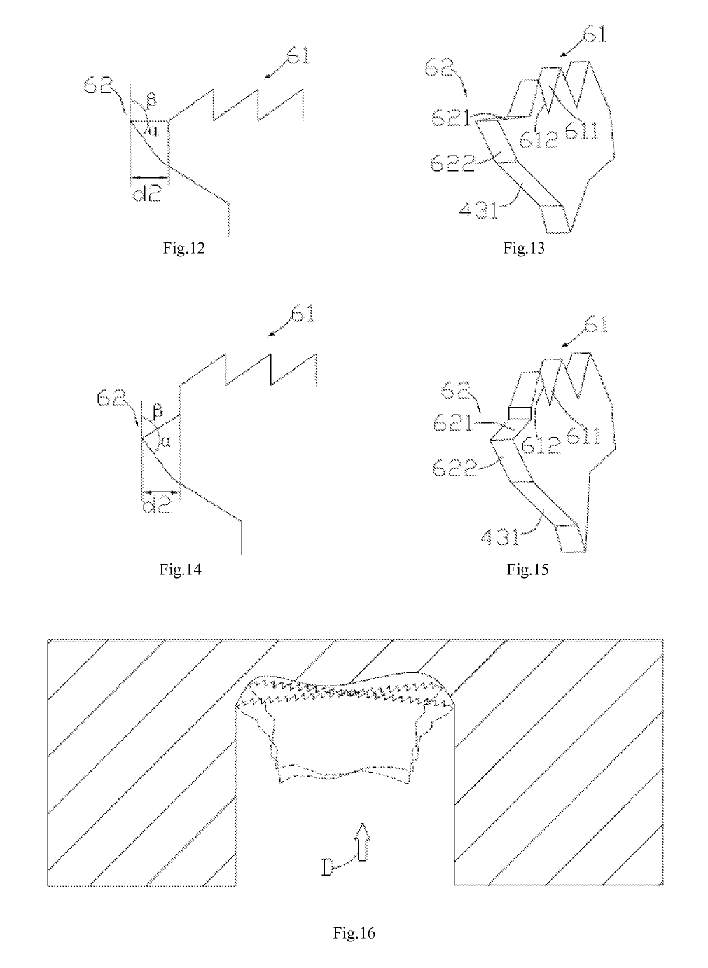

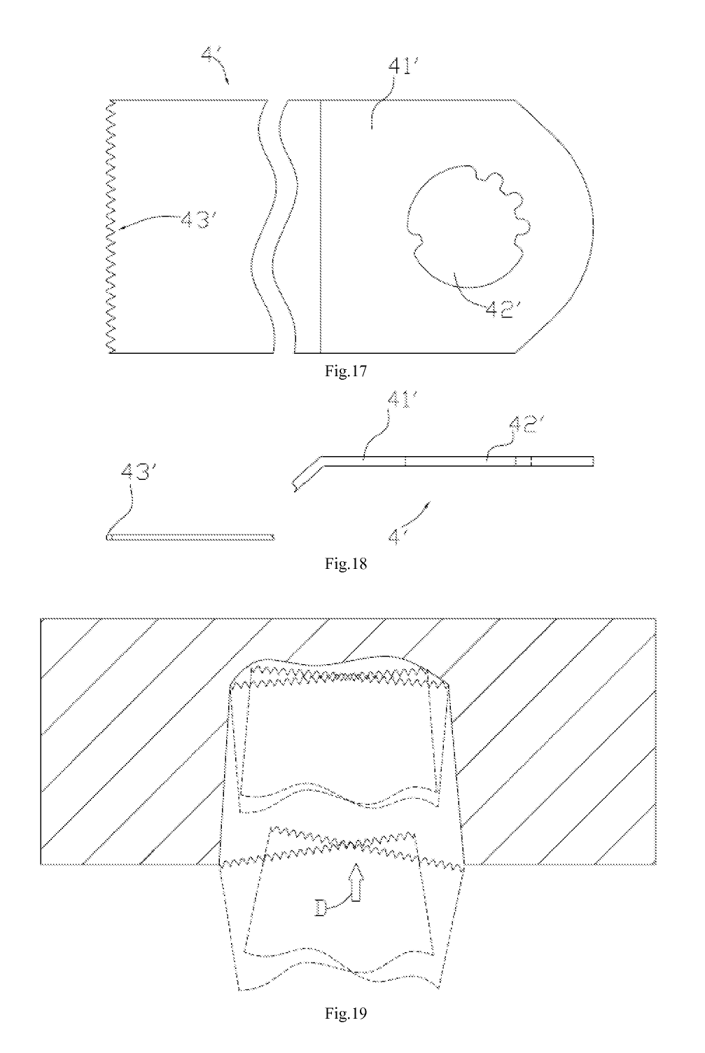

FIGS. 8-9 and FIGS. 12-13 disclose a portion of the cutting element 4 according to a third embodiment, wherein the second cutting surface 612 of the first cutting portion 61 is connected to the third cutting surface 621 of the second cutting portion 62. In this embodiment, the angle α defined between the third cutting surface 621 and the fourth cutting surface 622 is between 30° and 150°. Preferably, in this embodiment, the angle α is 53°. The angle β formed between the third cutting surface 621 and the feeding direction is preferably less than or equal to 90°. For example, in this embodiment, the angle β is 90°.

FIGS. 14 and 15 disclose a portion of the cutting element 4 according to a fourth embodiment, wherein the second cutting surface 612 of the first cutting portion 61 is connected to the third cutting surface 621 of the second cutting portion 62 by a planar surface. In this embodiment, the angle α formed between the third cutting surface 621 and the fourth cutting surface 622 is between 30° and 150°. Preferably, in this embodiment, the angle α is 90°. The angle β formed between the third cutting surface 621 and the feeding direction is preferably less than or equal to 90°. For example, in this embodiment, the angle β is 30°.

The cutting elements described above and shown in the drawings are merely exemplary embodiments of the present invention and, as such, the protection scope of the present invention is to be defined by the claims.

What is claimed is:

1. A cutting element, adapted for an oscillating power tool in which an output shaft moves in an oscillating motion about its axis and having a motor and a transmission mechanism for converting a rotation motion of the motor into the oscillating motion of the output shaft about its axis, the cutting element comprising:
a main body extending in the longitudinal direction, the main body defining an axis extending in the longitudinal direction,
a mounting hole defined on a first end of the main body for engagement with the output shaft of the oscillating power tool; and
a cutting portion for acting on a work piece to be processed, the cutting portion being arranged on a second end of the main body opposite to the first end, and the cutting portion having a first cutting portion and a second cutting portion protruding from the first cutting portion laterally, the first cutting portion being arranged for cutting the work piece to be processed in a feeding direction, and the second cutting portion arranged for cutting the work piece in a direction substantially perpendicular to the feeding direction.

2. The cutting element according to claim 1, wherein the main body has a side surface, the first cutting portion has a first cutting surface and a second cutting surface, and the second cutting portion has a third cutting surface connected to the first cutting surface or the second cutting surface, and a fourth cutting surface connected to the side surface.

3. The cutting element according to claim 2, wherein a material of at least part of the second cutting portion has the same rigidity as a material of the first cutting portion.

4. The cutting element according to claim 3, wherein a material of the third cutting surface of the second cutting portion has the same rigidity as the material of the first cutting portion.

5. The cutting element according to claim 1, wherein the second cutting portion extends directly and protrudes from an end edge of the first cutting portion.

6. The cutting element according to claim 2, wherein the third cutting surface and the fourth cutting surface cooperatively define an angle α ranging from 30° to 150°.

7. The cutting element according to claim 2, wherein the third cutting surface has an angle β with respect to the feeding direction, the angle β is less than or equal to 90°.

8. The cutting element according to claim 1, wherein the first cutting portion has a top end defining a height with respect to the direction opposite to the feeding direction, and at least one second cutting portion is arranged within the height.

9. The cutting element according to claim 8, wherein the height is less than or equal to 10 mm.

10. The cutting element according to claim 1, wherein an inner side wall of the mounting hole defines a plurality of grooves of which each adjacent pair are connected by a side of the mounting hole.

11. The cutting element according to claim 2, wherein the side surface comprises a first side surface, a second side surface, and a third side surface, the first side surface, the second side surface, and the third side surface cooperatively define a groove adjacent to the cutting portion, the first side surface connected to the first end of the main body, the second side surface connected to the first side surface and the third side surface, and the third side surface connected to the fourth cutting surface.

12. The cutting element according to claim 1, wherein the first end of the main body is parallel to the second end of the main body.

13. The cutting element according to claim 3, wherein the first cutting portion and at least part of the second cutting portion are made of high speed steel.

14. The cutting element according to claim 1, wherein the cutting portion and the main body are made of different materials.

15. The cutting element according to claim 14, wherein the material of the cutting portion has a higher rigidity than the material of the main body.

16. The cutting element according to claim 15, wherein the material of the cutting portion is high speed steel and the material of the main body is high carbon steel.

17. The cutting element according to claim 1, wherein the first cutting portion is wave-shaped.

18. The cutting element according to claim 2, wherein the third cutting surface intersects the first cutting surface or the second cutting surface.

19. The cutting element according to claim 1, wherein the cutting element is mounted to the oscillating power tool and the second cutting portion protrudes from the first cutting portion laterally when the cutting element deflects a certain angle.
